(19) United States
(12) Patent Application Publication
(10) Pub. No.: US 2026/0204480 A1
(43) Pub. Date: Jul. 16, 2026

(54) MULTILAYER CERAMIC ELECTRONIC COMPONENT, ELECTRONIC DEVICE, AND MANUFACTURING METHOD OF THE MULTILAYER CERAMIC ELECTRONIC COMPONENT

(71) Applicant: TAIYO YUDEN CO., LTD., Tokyo (JP)

(72) Inventors: Eriko NUMATA, Tokyo (JP); Kunihiko NAGAOKA, Tokyo (JP); Tomomi MACHIDA, Tokyo (JP); Kazuyuki KOIDE, Tokyo (JP)

(73) Assignee: TAIYO YUDEN CO., LTD., Tokyo (JP)

(21) Appl. No.: 19/560,195

(22) Filed: Mar. 9, 2026

Related U.S. Application Data
(63) Continuation of application No. PCT/JP2024/031569, filed on Sep. 3, 2024.

(30) Foreign Application Priority Data
Sep. 29, 2023 (JP) 2023-170428

(51) Int. Cl. H01G 4/232; H01G 2/06; H01G 4/008; H01G 4/012; H01G 4/12; H01G 4/30

(52) U.S. Cl. CPC H01G 4/232; H01G 2/065; H01G 4/008; H01G 4/012; H01G 4/12; H01G 4/30

(57) ABSTRACT

A multilayer ceramic electronic component includes a multilayer body having a substantially rectangular parallelepiped shape, in which dielectric layers and internal electrode layers are alternately laminated; and external electrodes respectively provided on end surfaces out of six surfaces of the multilayer body, from which the internal electrode layers are drawn out, wherein the external electrodes respectively extend from the end surfaces to neighboring regions beside the end surfaces within four adjacent surfaces adjacent to the end surfaces, and thickness of at least one of the external electrodes is greater in a region closer to four corner portions of corresponding one of the end surfaces in the corresponding one of the end surfaces and the four adjacent surfaces.

### CROSS-REFERENCE TO RELATED APPLICATIONS

This application is a continuation application of PCT/JP2024/031569 filed on Sep. 3, 2024, which claims priority of Japanese Patent Application No. 2023-170428 filed on Sep. 29, 2023, the entire contents of each are incorporated herein by reference.

### FIELD

A certain aspect of the present disclosure relates to a multilayer ceramic electronic component, an electronic device, and a manufacturing method of the multilayer ceramic electronic component.

### BACKGROUND

For example, external electrodes of a multilayer ceramic capacitor are formed by immersing a substantially rectangular parallelepiped multilayer body, in which dielectric layers and internal electrode layers are alternately laminated, in a dip bath filled with a conductive paste and applying the conductive paste to end faces of the multilayer body (Refer to, for example, Japanese Examined Patent Publication No. 2019-91800).

### SUMMARY OF THE INVENTION

According to a first aspect of the present disclosure, there is provided a multilayer ceramic electronic component including: a multilayer body having a substantially rectangular parallelepiped shape, in which dielectric layers and internal electrode layers are alternately laminated; and external electrodes respectively provided on end surfaces out of six surfaces of the multilayer body, from which the internal electrode layers are drawn out, wherein the external electrodes respectively extend from the end surfaces to neighboring regions beside the end surfaces within four adjacent surfaces adjacent to the end surfaces, and thickness of at least one of the external electrodes is greater in a region closer to four corner portions of corresponding one of the end surfaces in the corresponding one of the end surfaces and the four adjacent surfaces.

According to a second aspect of the present disclosure, there is provided an electronic device including: a multilayer ceramic electronic component; a circuit board on which the multilayer ceramic capacitor 1 is mounted, wherein the multilayer ceramic electronic component includes a multilayer body having a substantially rectangular parallelepiped shape, in which dielectric layers and internal electrode layers are alternately laminated; and external electrodes respectively provided on end surfaces out of six surfaces of the multilayer body, from which the internal electrode layers are drawn out, wherein the external electrodes respectively extend from the end surfaces to neighboring regions beside the end surfaces within four adjacent surfaces adjacent to the end surfaces, and thickness of at least one of the external electrodes is greater in a region closer to four corner portions of corresponding one of the end surfaces in the corresponding one of the end surfaces and the four adjacent surfaces.

According to a third aspect of the present disclosure, there is provided a manufacturing method of a multilayer ceramic electronic component, including: forming a multilayer body having a substantially rectangular parallelepiped shape, in which dielectric layers and internal electrode layers are alternately laminated; and forming external electrodes by applying and baking conductive paste to end surfaces out of six surfaces of the multilayer body, from which the internal electrode layers are drawn out, wherein in the forming of the external electrodes, a posture of the multilayer body is maintained so that one of four corner portions of at least one of the end surfaces is at the lowest position in a vertical direction, and the one of the four corner portions is immersed in a storage tank for the conductive paste provided below the multilayer body in the vertical direction, and then is lifted up from the storage tank to apply the conductive paste to the at least one of the end surface.

### BRIEF DESCRIPTION OF THE DRAWINGS

FIG. 1 is a perspective view of an example of a multilayer ceramic capacitor.

FIG. 2 is a sectional view of the multilayer ceramic capacitor taken along a line A-A in FIG. 1.

FIG. 3 is a sectional view of the multilayer ceramic capacitor taken along a line B-B in FIG. 2.

FIG. 4 is a sectional view of the multilayer ceramic capacitor taken along a line C-C in FIG. 2.

FIG. 5A is a plan view of an upper surface of the multilayer ceramic capacitor as viewed from a front.

FIG. 5B is a plan view of a side surface of the multilayer ceramic capacitor as viewed from a front.

FIG. 6A is a plan view of one end surface of the multilayer ceramic capacitor as viewed from a front.

FIG. 6B is a plan view of the other end surface of the multilayer ceramic capacitor as viewed from a front.

FIG. 7A is a plan view of an upper surface of a comparative multilayer ceramic capacitor as viewed from a front.

FIG. 7B is a plan view of a side surface of the comparative multilayer ceramic capacitor as viewed from a front.

FIG. 8A is a plan view of one end surface of the comparative multilayer ceramic capacitor as viewed from a front.

FIG. 8B is a plan view of the other end surface of the comparative multilayer ceramic capacitor as viewed from a front.

FIG. 9 is a sectional view of an external electrode covering a corner portion of a multilayer body.

FIG. 10 is a flowchart illustrating an example of a manufacturing process of the multilayer ceramic capacitor.

FIGS. 11A to 11C are sectional views of examples of a green sheet formation process, an internal electrode pattern formation process, and a lamination and pressure bonding process.

FIGS. 12 to 17 are perspective views of a multilayer body in an example of a base electrode layer formation process according to a dip method.

### DETAILED DESCRIPTION

At corners of each end surface of the multilayer body, the conductive paste is liable to be thinned because they are boundaries with other two adjacent surfaces, and thus some surfaces of the multilayer body may be exposed.

### Embodiment

### (Structure of Multilayer Ceramic Capacitor)

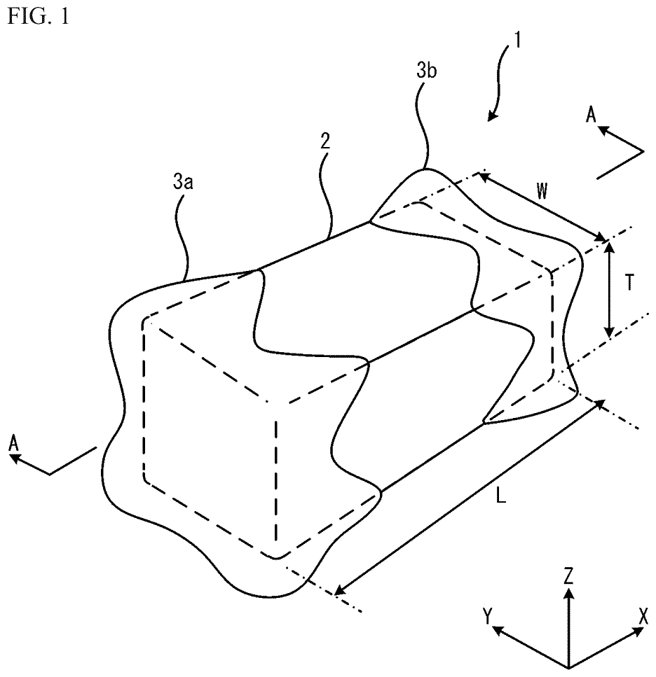

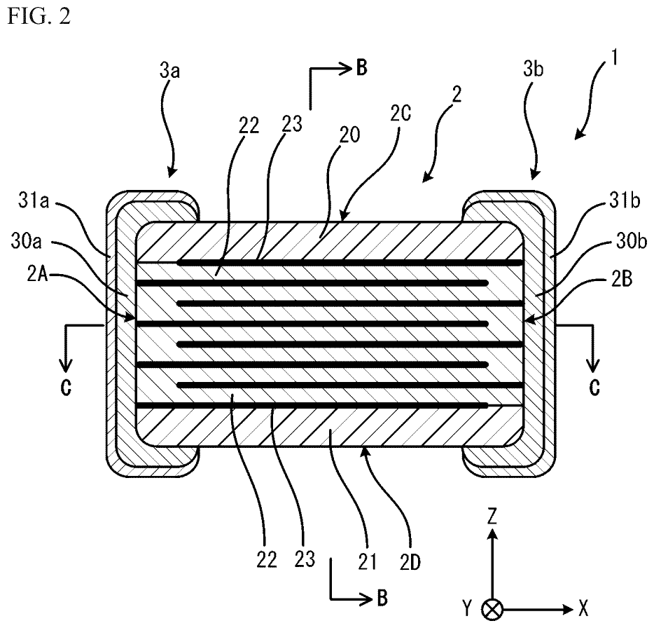

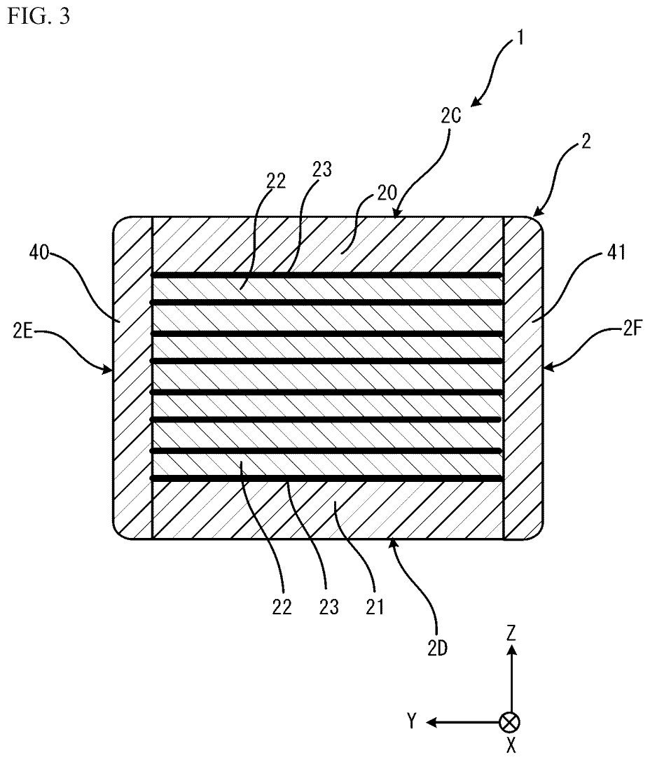

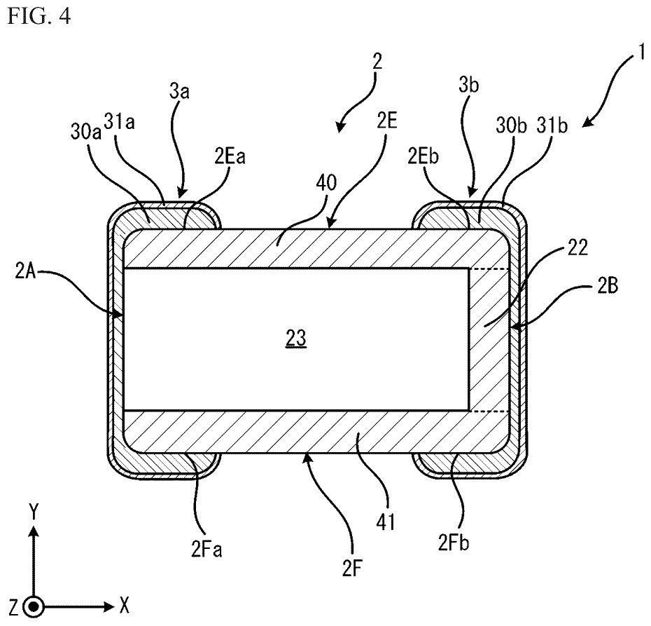

FIG. 1 is a perspective view of an example of a multilayer ceramic capacitor 1. FIG. 2 is a sectional view of the multilayer ceramic capacitor 1 taken along a line A-A in FIG. 1. FIG. 3 is a sectional view of the multilayer ceramic capacitor 1 taken along a line B-B in FIG. 2. FIG. 4 is a sectional view of the multilayer ceramic capacitor 1 taken along a line C-C in FIG. 2.

A multilayer ceramic capacitor 1 has a multilayer body 2 having a substantially rectangular parallelepiped shape and external electrodes 3a and 3b provided on a pair of end surfaces 2A and 2B facing each other in the multilayer body 2. The multilayer ceramic capacitor 1 is an example of a multilayer ceramic electronic component. Other examples of the multilayer ceramic electronic component include a multilayer ceramic varistor and a multilayer ceramic thermistor, and in this embodiment, the multilayer ceramic capacitor 1 is exemplified as a representative example thereof.

FIGS. 1 to 4 show X direction, Y direction, and Z direction which are perpendicular to each other. The X direction is a length (L) direction of the multilayer ceramic capacitor 1, and coincides with a direction in which the pair of end surfaces 2A and 2B of the multilayer body 2 face each other. The Y direction is a width (W) direction of the multilayer ceramic capacitor 1, and coincides with a direction in which a pair of side surfaces 2E, and 2F of the multilayer body 2 face each other. The Z direction is a height (T) direction of the multilayer ceramic capacitor 1, and coincides with a direction in which an upper surface 2C and a lower surface 2D of the multilayer body 2 face each other and a lamination direction of the multilayer body 2.

The multilayer body 2 is provided with the upper surface 2C, the lower surface 2D, the pair of end surfaces 2A and 2B, and the pair of side surfaces 2E and 2F. The upper surface 2C and the lower surface 2D are substantially flat surfaces facing each other in the lamination direction. The pair of end surfaces 2A and 2B are substantially flat surfaces facing each other in the longitudinal direction, and the pair of side surfaces 2E and 2F are substantially flat surfaces facing each other in the width direction. Also, the upper surface 2C, the lower surface 2D, and the side surfaces 2E and 2F are examples of four adjacent surfaces adjacent to the end surfaces 2A and 2B.

FIG. 2 is a cross section of a vicinity of a center of the multilayer body 2 in the width direction, taken along the lamination direction. FIG. 3 is a cross section of a vicinity of a center of the multilayer body 2 in the length direction, taken along the lamination direction. Further, FIG. 4 is a cross section of a vicinity of a center of the multilayer body 2 in the height direction,

taken along the length direction.

The multilayer body 2 has a multilayer structure wherein dielectric layers 22, which are mainly composed of a ceramic material functioning as a dielectric, and internal electrode layers 23 are alternately laminated, and a pair of cover layers 20 and 21 are laminated so as to sandwich the dielectric layers 22 and the internal electrode layers 23 from both sides in the lamination direction. In the multilayer body 2, a section sandwiched between a pair of internal electrode layers 23 adjacent to each dielectric layer 22 contributes to an electrostatic capacitance of the multilayer ceramic capacitor 1 and is referred to a “capacitance layer”.

The cover layers 20 and 21 sandwich the capacitance layers from both sides in the lamination direction. Both ends of the cover layers 20 and 21 in the length direction have curved surfaces.

The multilayer body 2 is provided with side margins 40 and 41 forming the side surfaces 2E and 2F. The side margins 40 and 41 extends in the length direction and sandwich a laminated region of the internal electrode layers 23 and the dielectric layers 22, that is, the capacitance layers from both sides in the width direction. The side margins 40 and 41 are mainly composed of the same ceramic material as the dielectric layer 22.

The internal electrode layers 23 have a substantially rectangular shape in a front view in the lamination direction and face each other with the dielectric layer 22 interposed therebetween in the lamination direction. One end of the internal electrode layer 23 is alternately drawn out to the end surfaces 2A and 2B along the lamination direction and connected to the external electrodes 3a and 3b.

The dielectric layer 22 has, for example, a ceramic material having a perovskite structure represented by a general formula ABO3 as a main phase. The perovskite structure contains ABO_{3-α} that is not in the stoichiometric composition. For example, the ceramic material can be selected from at least one of BaTiO₃ (barium titanate), CaZrO₃ (calcium zirconate), CaTiO₃ (calcium titanate), SrTiO₃ (strontium titanate), MgTiO₃ (magnesium titanate), and Ba_{1-x-y}CaₓSr_{y}Ti_{1-z}Zr_{z}O₃ (0≤x≤1, 0≤y≤1, 0≤z≤1) forming the perovskite structure can be selected and used. Ba_{1-x-y}CaₓSr_{y}Ti_{1-z}Zr_{z}O₃ is barium strontium titanate, barium calcium titanate, barium zirconate, barium zirconate titanate, calcium zirconate titanate, barium calcium zirconate titanate, and the like. The thickness of the dielectric layer 22 is, for example, 0.3 to 4.0 μm or less.

The internal electrode layer 23 is mainly composed of a base metal such as Ni (nickel), Cu (copper), or Sn (tin). The internal electrode layer 23 may be made of a noble metal such as Pt (platinum), Pd (palladium), Ag (silver), or Au (gold), or an alloy containing these metals. The thickness of the internal electrode layer 23 is, for example, 0.05 to 0.6 μm or less.

The external electrodes 3a and 3b respectively cover the end surfaces 2A and 2B of the multilayer body 2 which face each other in the length direction of the multilayer ceramic capacitor 1. Further, the external electrodes 3a and 3b extend on the upper surface 2C, the lower surface 2D, and the side surfaces 2E and 2F. However, the external electrodes 3a and 3b are spaced apart from each other on the upper surface 2C, the lower surface 2D, and the side surfaces 2E and 2F.

The external electrodes 3a and 3b include base electrode layers 30a and 30b and plating layers 31a and 31b, respectively. The plating layers 31a and 31b cover the base electrode layers 30a and 30b positioned inside. The main components of the base electrode layers 30a and 30b include metals such as Ni (nickel) and Cu (copper), and the main components of the plating layers 31a and 31b include metals such as Ni (nickel) and Sn (tin). Additionally, the plating layers 31a and 31b may be provided as a plurality of metal layers having different main components.

The external electrodes 3a and 3b are formed in such a manner that thickness is not uniform as shown in FIG. 1 and becomes greater in a region closer to four corners of the end surfaces 2A and 2B which are vertices of the multilayer body 2. Therefore, regions of the external electrodes 3a and 3b covering the corners are formed so as to protrude to the outside of the multilayer body 2 in the X direction, the Y direction, and the Z direction. Detail of a shape of the external electrodes 3a and 3b is described below.

### (Shape of External Electrode)

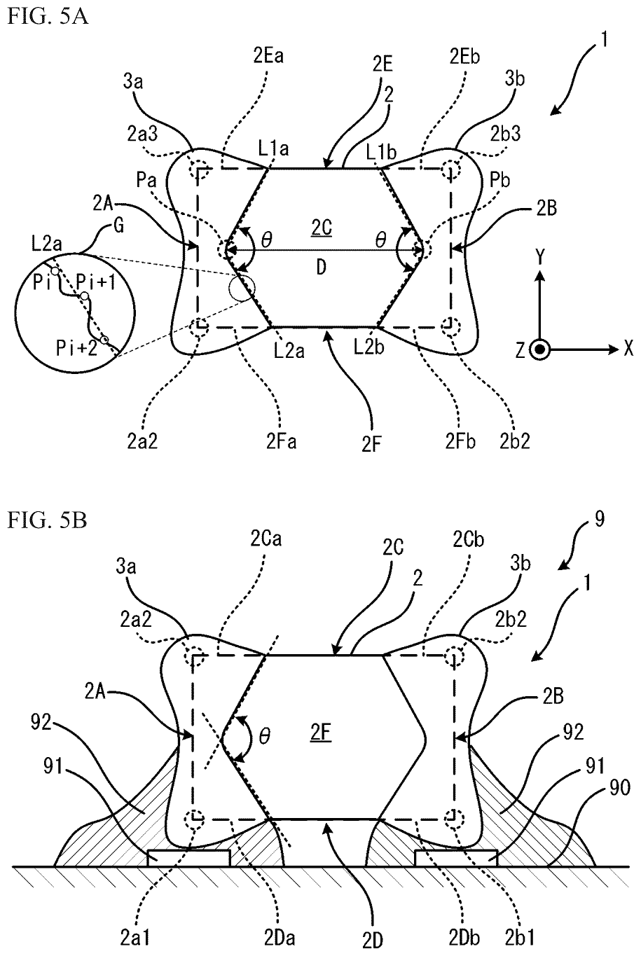

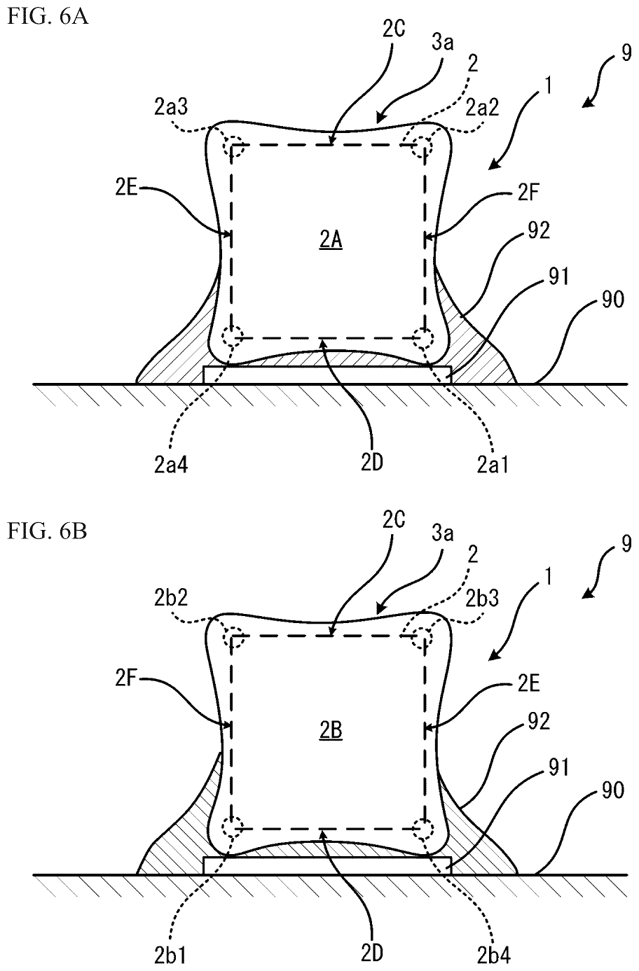

FIG. 5A is a plan view of the upper surface 2C of the multilayer ceramic capacitor 1 as viewed from a front. FIG. 5B is a plan view of a side surface 2F of the multilayer ceramic capacitor 1 as viewed from a front. FIG. 6A is a plan view of one end surface 2A of the multilayer ceramic capacitor 1 as viewed from a front. FIG. 6B is a plan view of the other end surface 2B of the multilayer ceramic capacitor 1 as viewed from a front. In FIGS. 5A, 5B, 6A, and 6B, hidden parts of the multilayer body 2 behind the external electrodes 3a and 3b are indicated by dotted lines.

FIGS. 5B, 6A, and 6B also show a circuit board 90 on which the multilayer ceramic capacitor 1 is mounted in an electronic device 9 such as a computer. A flat electrode pad 91 is provided on the circuit board 90. The multilayer ceramic capacitor 1 is mounted on the circuit board 90 by the solder 92 in a state where the external electrodes 3a and 3b are in contact with the flat electrode pads 91.

The external electrodes 3a and 3b extend from the end surfaces 2A and 2B to neighboring regions 2Ca, 2Cb, 2Da, 2 Db, 2Ea, 2Eb, 2Fa, and 2Fb beside the end surfaces 2A and 2B within the upper surface 2C, the lower surface 2D, and the side surfaces 2E and 2F. The thicknesses of the external electrodes 3a and 3b are greater in regions closer to the four corner portions 2a1 to 2a4 of the end surface 2A and the four corner portions 2b1 to 2b4 of the end surface 2B in the end surfaces 2A, 2B, the upper surface 2C, the lower surface 2D, and the side surfaces 2E, 2F.

Therefore, the thicknesses of the external electrodes 3a and 3b are largest in the region covering the corner portions 2a1 to 2a4 and 2b1 to 2b4. On the other hand, the thicknesses of the external electrodes 3a and 3b are smallest at central portions of the end surfaces 2A and 2B and at intermediate portions between two adjacent corner portions out of the corner portions 2a1 to 2a4 and 2b1 to 2b4. The external electrodes 3a and 3b are formed by a dipping method described later so as to protrude to the outside of the multilayer body 2 at the corner portions 2a1 to 2a4 and 2b1 to 2b4.

In this way, the thicknesses of the external electrodes 3a and 3b are sufficiently ensured in the corner portions 2a1 to 2a4 and 2b1 to 2b4 of the multilayer body 2. This effectiveness can also be obtained even in a case where at least one of the thicknesses of the external electrodes 3a and 3b is formed as described above.

Edges of the external electrodes 3a and 3b have a substantially V-shape when the upper surface 2C and the side surface 2F are viewed from the front. Therefore, the external electrodes 3a and 3b covering the corner portions 2a1 to 2a4 and 2b1 to 2b4 extend far outward from the multilayer body 2, and moisture is less likely to reach the internal electrode layers 23 in vicinities of the corner portions 2a1 to 2a4 and 2b1 to 2b4 from outside. Although front views of the lower surface 2D and the side surface 2E of the multilayer ceramic capacitor 1 are not illustrated, the front views are similar to those of FIGS. 5A and 5B. Angles θ of the substantially V-shaped edges may be substantially the same or different between the upper surface 2C and the side surface 2F.

The angles θ are calculated, for example, in a case of the upper surface 2C, as an angle formed by approximate straight lines L1a, L2a, L1b, L2b drawn from two reference points Pa and Pb on the edges where the distance D between the edges of the external electrodes 3a and 3b in the length direction (X direction) of the multilayer ceramic capacitor 1 is longest, extending toward the side surfaces 2E and 2F along the edges. Specifically, an angle θ on a side of the external electrode 3a is determined by the approximate straight lines L1a and L2a, and an angle θ on a side of the external electrode 3b is determined by the approximate straight lines L1b and L2b.

A symbol G refers to an enlarged view of a part of the edge of the external electrode 3a. The approximate straight line L2a can be obtained by using, for example, the least square method for coordinates (x, y) of a plurality of sampling points Pi (i=1 to N (positive integer)) on the edge detected at predetermined intervals in the X direction or the Y direction. Other approximate straight lines L1a, L1b, and L2b can be obtained by the same method as described above. Additionally, the angles θ on the lower surface 2D and the side surfaces 2E and 2F can also be determined in the same manner as described above.

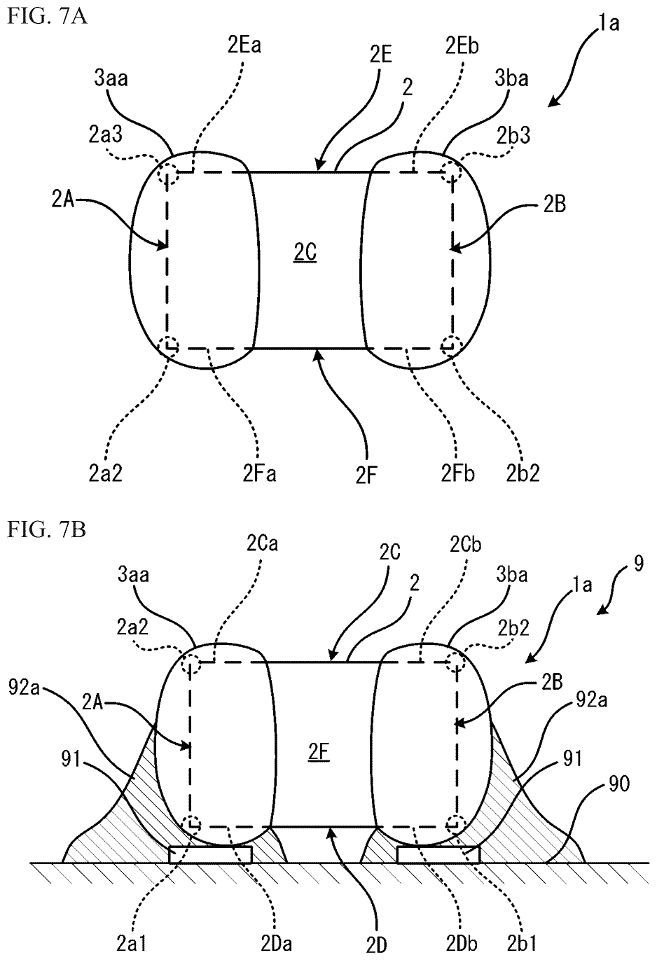

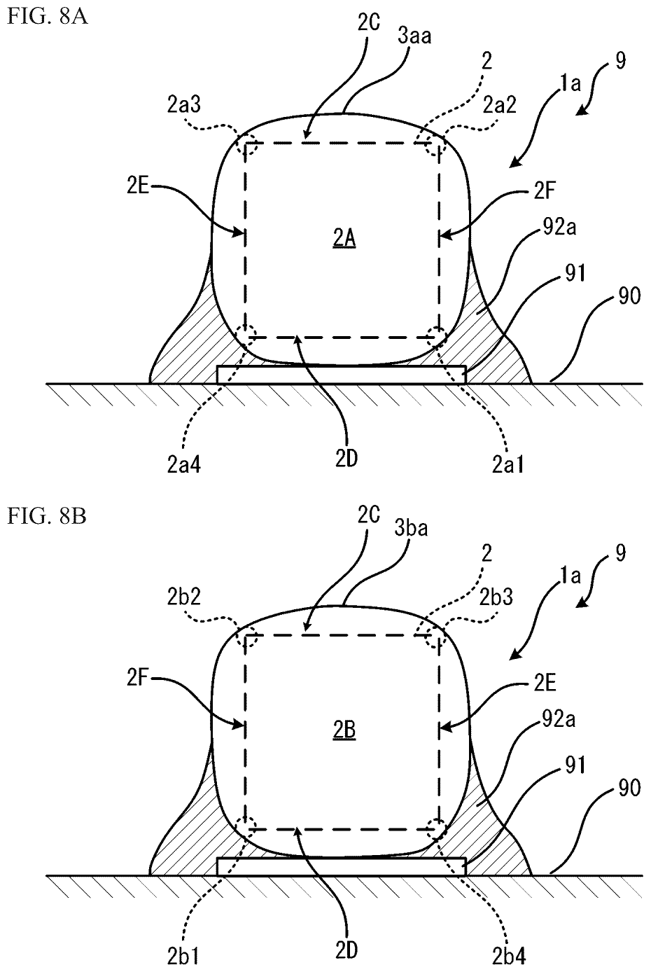

FIG. 7A is a plan view of the upper surface 2C of a comparative multilayer ceramic capacitor 1a as viewed from a front. FIG. 7B is a plan view of the side surface 2F of the comparative multilayer ceramic capacitor 1a as viewed from a front. FIG. 8A is a plan view of one end surface 2A of the comparative multilayer ceramic capacitor 1a as viewed from the front. FIG. 8B is a plan view of the other end surface 2B of the comparative multilayer ceramic capacitor 1a as viewed from the front. In FIGS. 7A, 7B, 8A, and 8B, the same reference numerals are given to the same components as those in FIGS. 5A, 5B, 6A, and 6B, and the description thereof will be omitted. A hidden parts of the multilayer body 2 behind the external electrodes 3aa and 3ba are indicated by dotted lines.

FIGS. 7B, 8A, and 8B show a circuit board 90 on which the comparative multilayer ceramic capacitor 1a is mounted in the electronic device 9. The comparative multilayer ceramic capacitor 1a is mounted on the circuit board 90 by the solder 92a in a state where the external electrodes 3aa and 3ba are in contact with the electrode pads 91.

Thicknesses of the external electrodes 3aa and 3ba are greater in regions closer to the center of the end surfaces 2A and 2B, unlike the multilayer ceramic capacitor 1 of the embodiment. The external electrodes 3aa and 3ba extend from the end surfaces 2A and 2B to neighboring regions 2ca, 2cb, 2da, 2db, 2ea, 2eb, 2fa, and 2fb beside the end surfaces 2A and 2B within the upper surface 2C, the lower surface 2D, and the side surfaces 2E and 2F. The thicknesses of the external electrodes 3aa and 3ba are greater in regions closer to centers of the neighboring regions 2ca, 2cb, 2da, 2db, 2ea, 2eb, 2fa, and 2fb in the upper surface 2C, the lower surface 2D, and the side surfaces 2E, 2F. Therefore, the thicknesses of the external electrodes 3aa and 3ba becomes smallest in regions covering the corner portions 2a1 to 2a4 and 2b1 to 2b4.

The multilayer ceramic capacitor 1 of the embodiment and the comparative multilayer ceramic capacitor 1a are compared as follows. The thicknesses of the regions covering the corner portions 2a1 to 2a4 and 2b1 to 2b4 of the external electrodes 3a and 3b of the embodiment can be made greater than those of the external electrodes 3aa and 3ba of the comparative multilayer ceramic capacitor 1a. Therefore, according to the embodiment, it is possible to effectively suppress the invasion of moisture into the inside of the multilayer body 2 at the corner portions 2a1 to 2a4 and 2b1 to 2b4.

Further, since the external electrodes 3a and 3b of the embodiment project outward at the corner portions 2a1 to 2a4 and 2b1 to 2b4, posture of the multilayer ceramic capacitor 1 is stabilized, for example, in being packaged. Thus, the multilayer ceramic capacitor 1 of the embodiment is less likely to be packaged in an inclined posture than the comparative multilayer ceramic capacitor 1a. Furthermore, since contact area between the external electrodes 3a and 3b and the solder 92 in the embodiment can be greater than contact area between the external electrodes 3aa and 3ba and the solder 92a for the comparative multilayer ceramic capacitor 1a, connection strength between the multilayer ceramic capacitor 1 and the circuit board 90 is improved as compared with the comparative multilayer ceramic capacitor 1a.

Further, in the front view of the side surface 2F, the external electrodes 3a and 3b of the embodiment have a concave center in the lamination direction, while the external electrodes 3aa and 3ba of the comparative multilayer ceramic capacitor 1a have a swollen center in the lamination direction. Therefore, a contact angle between the external electrodes 3a and 3b and the solder 92 in the embodiment is greater than a contact angle between the external electrodes 3aa and 3ba and the solder 92a for the comparative multilayer ceramic capacitor 1a. Thus, excessive wetting of the solder 92 are suppressed on the external electrodes 3a and 3b of the embodiment as compared with the external electrodes 3aa and 3ba of the comparative multilayer ceramic capacitor 1a.

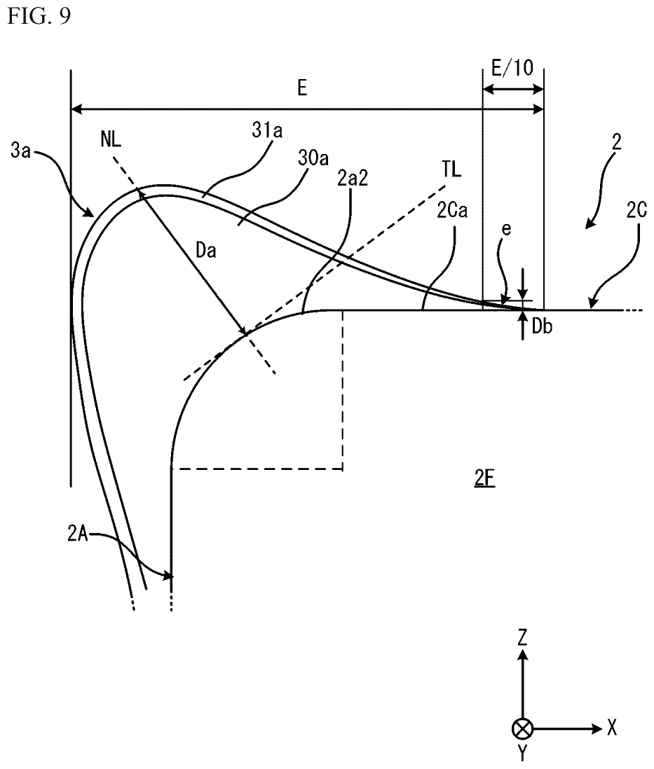

FIG. 9 is a sectional view of the external electrode 3a covering the corner portion 2a2 of the multilayer body 2. FIG. 9 shows a cross section of the external electrode 3a along the side surface 2F of the multilayer body 2 when the side surface 2F is viewed from the front. The thickness of the plating layer 31a is substantially uniform except for end portions, whereas the thickness of the base electrode layer 30a is greater in a region closer to the corner portion 2a2. That is, the shape of the external electrode 3a described above is based on a shape of the base electrode layer 30a. The same applies to a shape of the external electrode 3b.

The thickness Da of the external electrode 3a at the corner portion 2a2 is defined as a distance on a normal line NL with respect to a tangent line TL of the corner portion 2a2, from a surface of the corner portion 2a2 to a surface of the external electrode 3a, for example. The thickness Da of the external electrode 3a at the corner portion 2a2 is preferably 2.5 times or more the thickness Db of the external electrode 3a at an end portion e of a central side of the multilayer body 2 within the neighboring region 2Ca in the upper surface 2C, where the external electrode 3a is extended, and is preferably 1.2% or more of the height T or width W of the multilayer body 2 corresponding to a length of one side of the end surface 2A, because the thickness Da can be formed in a manner that the surface of the multilayer body 2 is less likely to be exposed. The thickness Db of the external electrode 3a at the end portion e may be a value measured at a position of one tenth (E/10) of a dimension E of the external electrode 3a in the length direction when viewed from an edge of the external electrode 3a on the upper surface 2C. Although the thicknesses Da and Db of one external electrode 3a are described in the present embodiment, the thickness of the other external electrode 3b is also the same as described above.

$$S / 2 E < tan ( θ / 2 ) < S / E \qquad ( 1 )$$

The angle θ of the substantially V-shape formed by the edge of the external electrode 3a shown in FIGS. 5A and 5B is preferable when the dimension E of the external electrode 3a in the length direction and a dimension S of the longest side of the end surface 2A satisfy the above equation (1), since the external electrode 3a at the corner portion 2a2 can be longer enough to improve moisture resistance of the multilayer ceramic capacitor 1. Here, the dimension S of the longest side of the end surface 2A is the longer of the height (T) and the width (W) of the multilayer body 2. In this example, the angle θ of one external electrode 3a is described, but the same applies to the angle of the other external electrode 3b.

### (Manufacturing Process of Multilayer Ceramic Capacitor)

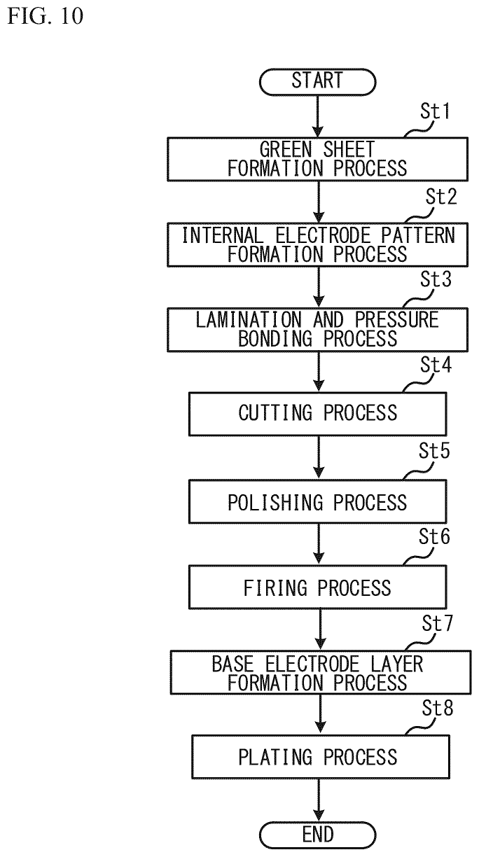

FIG. 10 is a flowchart illustrating an example of a manufacturing process of the multilayer ceramic capacitor 1. This manufacturing process is an example of a manufacturing method of the multilayer ceramic electronic component.

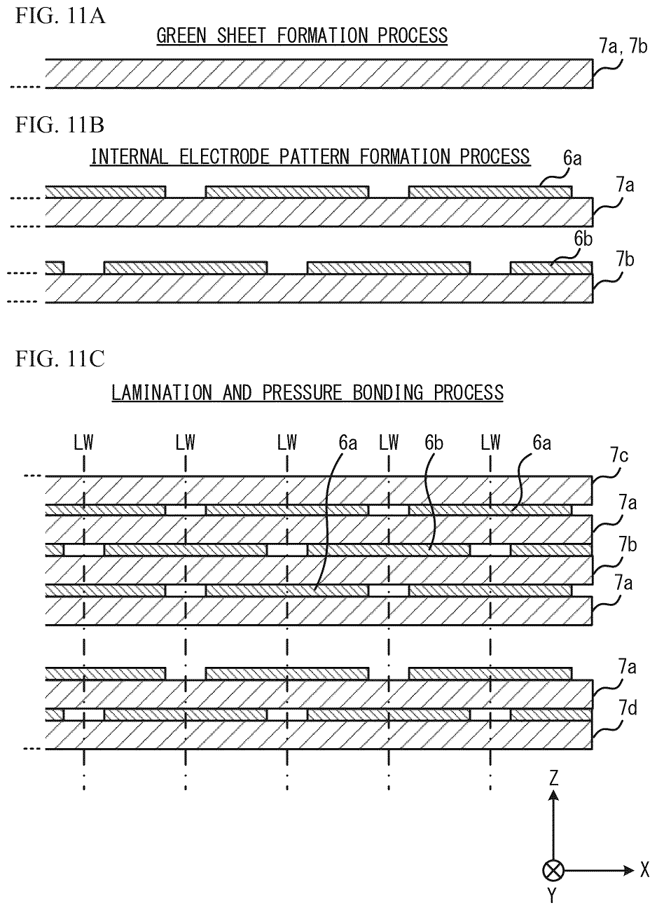

FIGS. 11A to 11C are sectional views of examples of the green sheet formation process St1, the internal electrode pattern formation process St2, and the lamination and pressure bonding process St3. FIGS. 11A to 11C are cross sections of the multilayer ceramic capacitor 1 taken along the lamination direction and the length direction.

### (Green Sheet Formation Process)

First, the green sheet formation process St1 is performed. In the green sheet formation process St1, a ceramic slurry is applied onto base substrates (not shown) to form green sheets 7a and 7b. The ceramic slurry is obtained by adding a binder such as polyvinyl butyral (PVB) resin, an organic solvent such as ethanol or toluene, and a plasticizer to a dielectric material obtained by adding various additive compounds (sintering aid, etc.) to ceramic powder, and then wet-mixing the mixture. The green sheets 7a and 7b are coated on the base substrates by, for example, a die coater method or a doctor blade method using the ceramic slurry, and dried. The base substrates are, for example, a PET (polyethylene terephthalate) film.

As an additive compound of the ceramic powder, an oxide of Mg (magnesium), Mn (manganese), V (vanadium), Cr (chromium), a rare earth element (Y (yttrium), Sm (samarium), Eu (europium), Gd (gadolinium), Tb (terbium), Dy (dysprosium), Ho (holmium), Er (erbium), Tm (thulium) or Yb (ytterbium)), and an oxide or a glass of Co (cobalt), Ni (nickel), Li (lithium), B (boron), Na (sodium), K (potassium) or Si (silicon) is used.

### (Internal Electrode Pattern Formation Process)

Next, the internal electrode pattern formation process St2 is performed. In the internal electrode pattern formation process St2, the internal electrode patterns 6a and 6b are formed by applying conductive paste onto the green sheets 7a and 7b, respectively. The internal electrode patterns 6a and 6b become the internal electrode layers 23 after firing. The internal electrode patterns 6a and 6b are shifted from each other by half a pitch in the X direction.

In the internal electrode pattern formation process St2, the conductive paste of a metal for forming the internal electrode layers 23 containing an organic binder is printed on the green sheets 7a and 7b by gravure printing or the like, thereby forming a plurality of internal electrode patterns 6a and 6b spaced from each other. A dielectric material is added to the conductive paste as a co-material. Means for the formation of the internal electrode patterns 6a and 6b are not limited to printing, and, instead, may be a vacuum deposition method such as sputtering.

### (Lamination and Pressure Bonding Process)

Next, a lamination and pressure bonding process St3 is performed. In the lamination and pressure bonding process St3, a plurality of green sheets 7a and 7b are alternately laminated and pressure bonded.

The plurality of green sheets 7a and 7b are sandwiched and pressed together from the top and bottom in the lamination direction by other green sheets 7c and 7d which become the cover layer 20 and 21 after firing. On a surface of the lowermost green sheet 7d, the internal electrode pattern 6b is formed by the same method as the internal electrode pattern formation process St2. Examples of means for the pressure bonding include, but are not limited to, a hydrostatic press.

### (Cutting Process)

Next, a cutting process St4 is performed. In the cutting step St4, the green sheets 7a to 7d bended by the lamination and pressure bonding process St3 are cut by, for example, a blade along a plurality of cut lines LW extending vertically and horizontally at a constant interval. Thus, the green sheets 7a to 7d are divided into a plurality of the multilayer bodies 2 in a pre-fired state. FIG. 11C shows the cut lines LW along the lamination direction and the width direction of the multilayer body 2. The end portions of the internal electrode patterns 6a and 6b are exposed on the end surfaces 2A and 2B, which are cut surfaces of the multilayer body 2. The processes from the green sheet formation process St1 to the cutting process St4 are an example of a process of forming the multilayer body 2.

### (Polishing Process)

Next, a polishing process St5 is performed. In the polishing process St5, the multilayer body 2 is polished by a barrel polishing method, for example, so that the corner portions 2a1 to 2a4 and 2b1 to 2b4 of the multilayer body 2 are rounded. Therefore, the corner portions 2a1 to 2a4 and 2b1 to 2b4 are curved, and thus the thicknesses of the external electrodes 3a and 3b can be greater than those in a case where the polishing process St5 is not performed. Nevertheless, the polishing process St5 may not be necessarily performed.

### (Firing Process)

Next, the firing process St6 is performed. In the firing process St6, the multilayer body 2 in a pre-fired state is subjected to a de-binding treatment in an N2 atmosphere at 250 to 500° C., and then fired in a reducing atmosphere having an oxygen partial pressure of 0.003 Pa at a firing temperature of 1200° C. or higher for about one hour, thereby sintering particles in the multilayer body 2. Thus, in the multilayer body 2, the green sheets 7a to 7d become the dielectric layers 22 and the cover layers 20 and 21, and the internal electrode patterns 6a and 6b become the internal electrode layers 23.

### (Base Electrode Layer Formation Process)

Next, a base electrode layer formation process St7 is performed. The base electrode layer formation process St7 is an example of a process of forming the external electrodes 3a and 3b by applying and baking a conductive paste to the end surfaces 2A and 2B of the multilayer body 2.

In the base electrode layer formation process St7, the conductive paste containing, for example, a metal powder, a glass frit, a binder and a solvent is applied to the end surfaces 2A and 2B of the multilayer body 2 and the neighboring regions 2ca, 2cb, 2da, 2db, 2ea, 2eb, 2fa, and 2fb on sides of the end surfaces 2A and 2B in the upper surface 2C, the lower surface 2D and the side surfaces 2E and 2F. After the application of the conductive paste, the conductive paste is dried to form the base electrode layers 30a and 30b. The binder and the solvent are evaporated by baking. The conductive paste is applied by a dip method as described below.

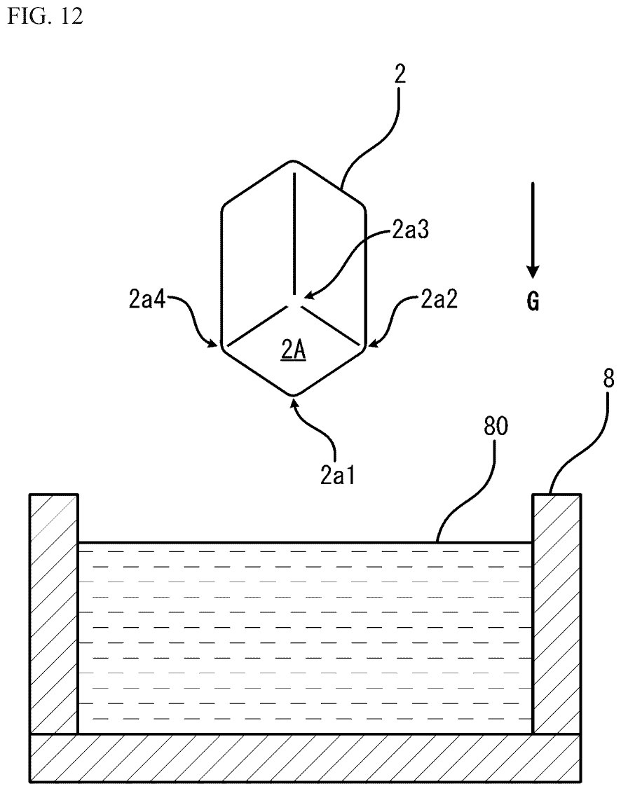

FIGS. 12 to 17 are perspective views of the multilayer body 2 in an example of the base electrode layer formation process St7 according to a dip method. In the base electrode layer formation process St7, first, the posture of the multilayer body 2 is maintained so that one of the corner portions 2a1 to 2a4 of one end surface 2A is positioned at the lowest position in a vertical direction G. Next, the one of the corner portions 2a1 to 2a4 is immersed in a storage tank 8 for a conductive paste 80, and then the one of the corner portions 2a1 to 2a4 is pulled out of the storage tank 8. The above process is repeated as to others of the corner portions 2a1 to 2a4. Thus, the conductive paste 80 is applied to the end surface 2A. Next, the posture of the multilayer body 2 is maintained so that one of the corner portions 2b1 to 2b4 of the other end surface 2B is positioned at the lowest position in the vertical direction G. Next, the one of the corner portions 2b1 to 2b4 is immersed in the storage tank 8 for the conductive paste 80, and then the one of the corner portions 2b1 to 2b4 is pulled out of the storage tank 8. The above process is repeated as to others of the corner portions 2b1 to 2b4. Thus, the conductive paste 80 is applied to the end surface 2B. Since the conductive paste is applied to the end surfaces 2A and 2B in the same manner, the following description exemplifies the one end surface 2A.

First, as shown in FIG. 12, the posture of the multilayer body 2 is maintained by using a dipping device (not shown) so that the corner portion 2a1 is at the lowest position in the vertical direction G. The storage tank 8 is provided below the multilayer body 2 in the vertical direction G. The posture of the multilayer body 2 is maintained such that a distance between the corner portion 2a1 and a liquid surface of the conductive paste 80 in the storage tank 8 is shorter than a distance between each one of the corner portions 2a2 to 2a4 and the liquid surface.

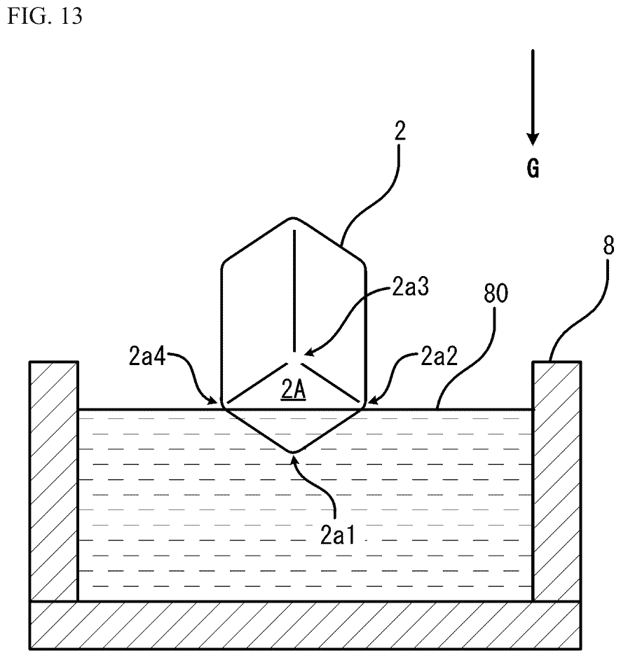

Next, as shown in FIG. 13, the multilayer body 2 is moved downward in the vertical direction by the dipping device in a state where the above-described posture is maintained, and is immersed in the storage tank 8. At this time, in the end surface 2A of the multilayer body 2, at least a substantially triangular shaped region within lines connecting the corner portions 2a1, 2a2, and 2a4 is immersed in the conductive paste 80.

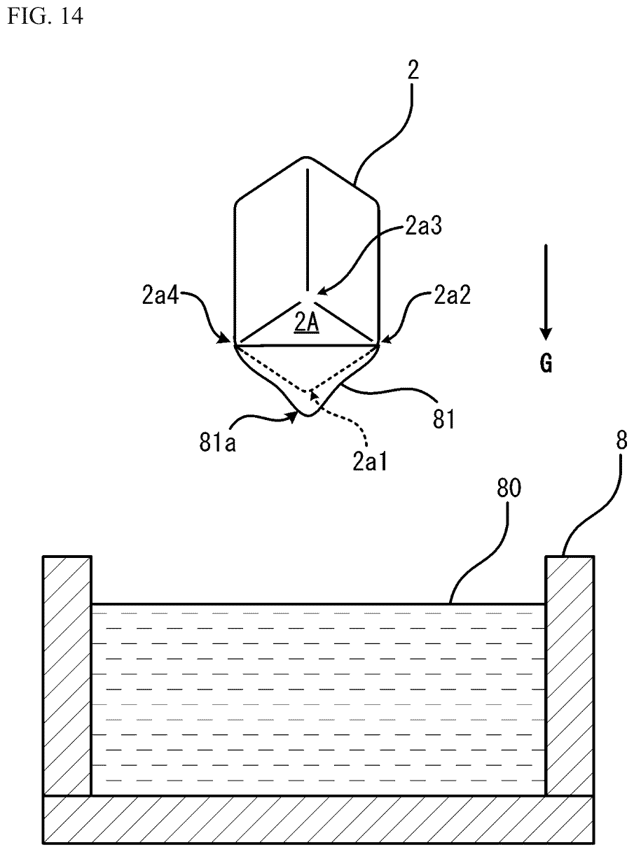

Next, as shown in FIG. 14, the multilayer body 2 is moved upward in the vertical direction by the dipping device in a state where the above-described posture is maintained, thus being lifted up from the storage tank 8. At this time, the conductive paste 81 is applied to the corner portion 2a1 and a surrounding region of the corner portion 2a1 immersed in the conductive paste 80. Since the posture of the multilayer body 2 is maintained such that the corner portion 2a1 is at the lowest position in the vertical direction G, the conductive paste 81 applied to the surrounding region is collected at the corner portion 2a1 by gravity to form a dripping portion 81a. Thus, the thickness of the base electrode layer 30a is greater at a closer region to the corner portion 2a1.

After the conductive paste 81 applied around the corner portion 2a1 is dried, the dipping device changes the posture of the multilayer body 2 so that the corner portion 2a2 is at the lowest position in the vertical direction G. The multilayer body 2 is moved downward in the vertical direction G by the dipping device in a state where the above-described posture is maintained, and is immersed in the storage tank 8. At this time, in the end surface 2A of the multilayer body 2, at least t a substantially triangular shaped region within lines connecting the corner portions 2a1, 2a2, and 2a3 is immersed in the conductive paste 80.

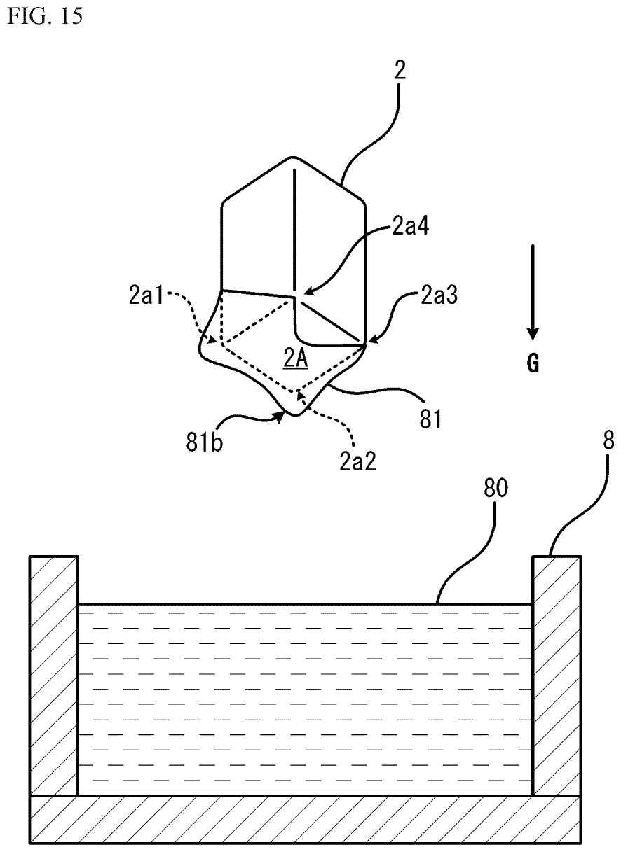

Next, as shown in FIG. 15, the multilayer body 2 is moved upward in the vertical direction G by the dipping device in a state where the above-described posture is maintained, thus being lifted up from the storage tank 8. Therefore, the applied region of the conductive paste 81 on the multilayer body 2 extends from a periphery of the corner portion 2a1 to a periphery of the corner portion 2a2. The conductive paste 81 which is newly applied and undried is collected at the corner portion 2a2 by gravity to form a dripping portion 81b. Thus, in a region where the conductive paste 81 is newly applied, the thickness of the base electrode layer 30a is greater at a region closer to the corner portion 2a2.

After the conductive paste 81 applied around the corner portion 2a2 is dried, the dipping device changes the posture of the multilayer body 2 so that the corner portion 2a3 is at the lowest position in the vertical direction G. The multilayer body 2 is moved downward in the vertical direction G by the dipping device in a state where the above-described posture is maintained, and is immersed in the storage tank 8. At this time, in the end surface 2A of the multilayer body 2, at least a substantially triangular shaped region within lines connecting the corner portions 2a2, 2a3, and 2a4 is immersed in the conductive paste 80.

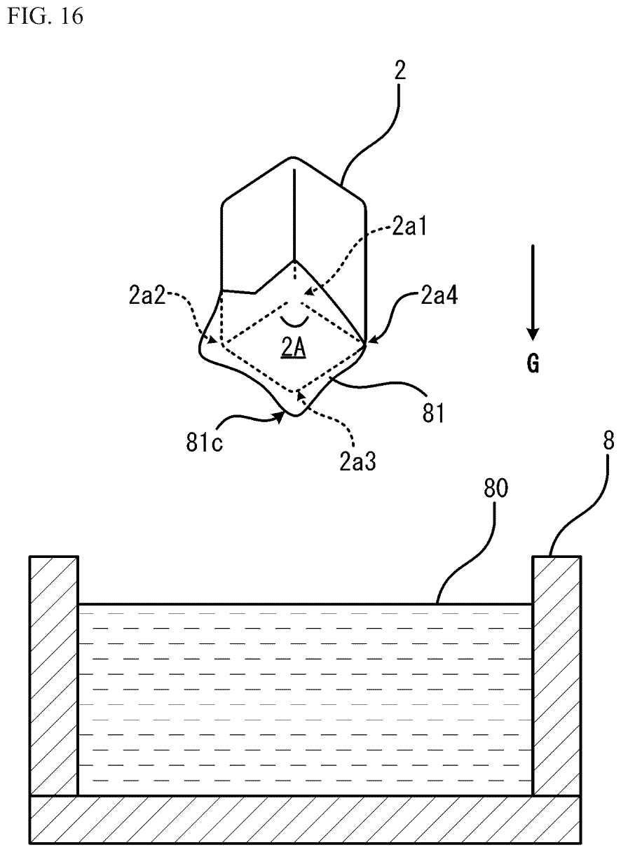

Next, as shown in FIG. 16, the multilayer body 2 is moved upward in the vertical direction by the dipping device in a state where the above-described posture is maintained, thus being lifted up from the storage tank 8. Therefore, the applied region of the conductive paste 81 on the multilayer body 2 extends from the peripheries of the corner portions 2a1 and 2a2 to a periphery of the corner portion 2a3. The conductive paste 81 which is newly applied and undried is collected at the corner portion 2a3 by gravity to form a dripping portion 81c. Thus, in a region where the conductive paste 81 is newly applied, the thickness of the base electrode layer 30a becomes greater at a region closer to the corner portion 2a3.

After the conductive paste 81 applied around the corner portion 2a3 is dried, the dipping device changes the posture of the multilayer body 2 so that the corner portion 2a4 is at the lowest position in the vertical direction G. The multilayer body 2 is moved downward in the vertical direction G by the dipping device in a state where the above-described posture is maintained, and is immersed in the storage tank 8. At this time, in the end surface 2A of the multilayer body 2, at least t a substantially triangular shaped region within lines connecting the corner portions 2a1, 2a3, and 2a4 is immersed in the conductive paste 80.

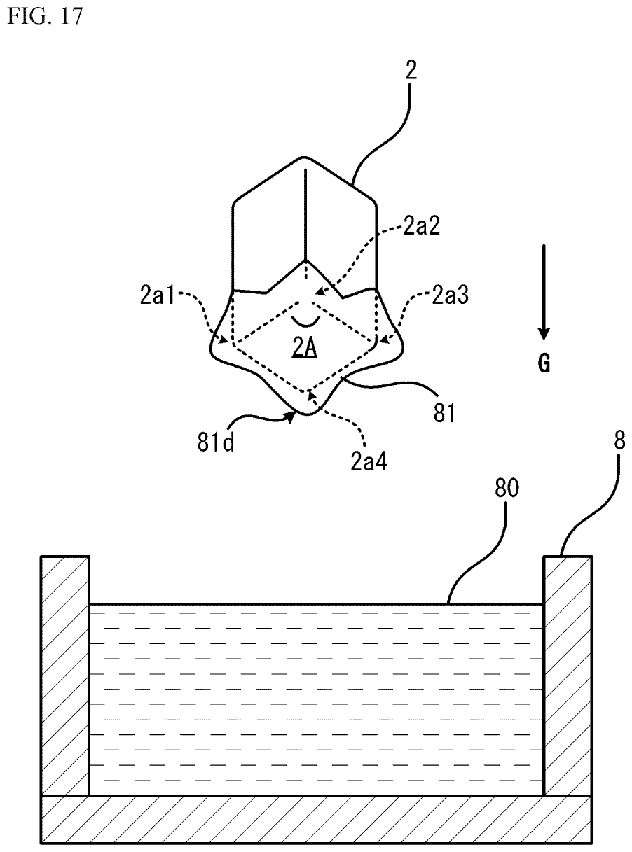

Next, as shown in FIG. 17, the multilayer body 2 is moved upward in the vertical direction G by the dipping device in a state where the above-described posture is maintained, thus being lifted up from the storage tank 8. Therefore, the applied region of the conductive paste 81 on the multilayer body 2 extends from the peripheries of the corner portions 2a1 to 2a3 to a periphery of the corner portion 2a4. The conductive paste 81 which is newly applied and undried is collected at the corner portion 2a4 by gravity to form a dripping portion 81d. Thus, in a region where the conductive paste 81 is newly applied, the thickness of the base electrode layer 30a is greater at a region closer to the corner portion 2a4. Thereafter, the conductive paste 81 around the corner portion 2a4 is also dried.

In this way, in the base electrode layer formation process St7, the base electrode layer 30a is formed on the end surface 2A so that the thickness becomes greater as a region of the multilayer body 2 is closer to the corner portions 2a1 to 2a4 by immersing the multilayer body 2 in the storage tank 8 with the corner portions 2a1 to 2a4 kept at the lowest position sequentially in the vertical direction G. Similarly, the end surface 2B is also formed with the base electrode layer 30b having a greater thickness as a region of the multilayer body 2 is closer to the corner portions 2b1 to 2b4 by immersing the multilayer body 2 in the storage tank 8 with the corner portions 2b1 to 2b4 kept at the lowermost positions sequentially in the vertical direction G. Therefore, according to the manufacturing process of the embodiment, the thicknesses of the external electrodes 3a and 3b covering the corner portions 2a1 to 2a4 and 2b1 to 2b4 can be sufficiently ensured. Instead, the base electrode layer 30a may be formed by preparing a mold shaped so that the thickness of the base electrode layer 30a becomes greater as a region is closer to the corner portions 2a1 to 2a4, and then flowing the conductive paste 81 into the mold, impregnating the end surface 2A of the multilayer body 2 with the conductive paste 81, and drying the conductive paste 81. The same means can be used for the end surface 2B.

Further, since the multilayer body 2 is immersed in the conductive paste 80 in an inclined posture with one of the corner portions 2a1 to 2a4 and 2b1 to 2b4 kept at the lowest positions sequentially in the vertical direction G, the conductive paste 81 applied to the upper surface 2C, the lower surface 2D, and the side surfaces 2E and 2F of the multilayer body 2 has a substantially V-shaped edge. Therefore, the external electrodes 3a and 3b have the substantially V-shaped edges on the upper surface 2C, the lower surface 2D, and the side surfaces 2E and 2F of the multilayer body 2.

The conductive paste 80 and 81 for forming the base electrode layers 30a and 30b is preferably made of nickel or copper as a main component, because a general metal material having good electrical conductivity can be used. However, the main component of the conductive paste 80 and 81 is not limited to the above, and may be other metal. The base electrode layer formation process St7 may be performed before the firing step St6. In this case, the base electrode layers 30a and 30b are co-fired with the multilayer body 2.

### (Plating Process)

Next, a plating process St8 is performed. In the plating process St8, the plating layers 31a and 31b are formed to cover the base electrode layers 30a and 30b by, for example, an electrolytic plating method. In this way, the multilayer ceramic capacitor 1 is manufactured.

The present invention is not limited to the specific embodiments, and various modifications and changes are possible within the scope of the gist of the present invention described in the claims.

What is claimed is:

1. A multilayer ceramic electronic component comprising:
a multilayer body having a substantially rectangular parallelepiped shape, in which dielectric layers and internal electrode layers are alternately laminated; and
external electrodes respectively provided on end surfaces out of six surfaces of the multilayer body, from which the internal electrode layers are drawn out, wherein the external electrodes respectively extend from the end surfaces to neighboring regions beside the end surfaces within four adjacent surfaces adjacent to the end surfaces, and
thickness of at least one of the external electrodes is greater in a region closer to four corner portions of corresponding one of the end surfaces in the corresponding one of the end surfaces and the four adjacent surfaces.

2. The multilayer ceramic electronic component according to claim 1, wherein,
when one of the four adjacent surfaces is viewed from front, the thickness of the at least one of the external electrodes at the corner portions is 2.5 times or more the thickness of the at least one of the external electrodes at an end portion of a central side of the multilayer body within the neighboring regions, and is 1.2% or more of a dimension of one side of the at least one of the end surfaces.

3. The multilayer ceramic electronic component according to claim 1, wherein
an edge of the at least one of the external electrodes has a substantially V-shape when one of the four adjacent surfaces is viewed from front.

4. The multilayer ceramic electronic component according to claim 3, wherein,
when the one of the four adjacent surfaces is viewed from the front, in a case that a dimension of the at least one of the external electrodes in a direction in which the end surfaces face each other is E, and that a dimension of the longest side of the at least one of the end surfaces is S, an angle θ of the substantially V-shaped shape satisfies S/2E<tan (θ/2)<S/E.

5. An electronic device comprising:
a multilayer ceramic electronic component;
a circuit board on which the multilayer ceramic capacitor is mounted, wherein the multilayer ceramic electronic component includes:
a multilayer body having a substantially rectangular parallelepiped shape, in which dielectric layers and internal electrode layers are alternately laminated; and
external electrodes respectively provided on end surfaces out of six surfaces of the multilayer body, from which the internal electrode layers are drawn out,
wherein the external electrodes respectively extend from the end surfaces to neighboring regions beside the end surfaces within four adjacent surfaces adjacent to the end surfaces, and
thickness of at least one of the external electrodes is greater in a region closer to four corner portions of corresponding one of the end surfaces in the corresponding one of the end surfaces and the four adjacent surfaces.

6. A manufacturing method of a multilayer ceramic electronic component, comprising:
forming a multilayer body having a substantially rectangular parallelepiped shape, in which dielectric layers and internal electrode layers are alternately laminated; and
forming external electrodes by applying and baking conductive paste to end surfaces out of six surfaces of the multilayer body, from which the internal electrode layers are drawn out, wherein
in the forming of the external electrodes, a posture of the multilayer body is maintained so that one of four corner portions of at least one of the end surfaces is at the lowest position in a vertical direction sequentially, and the one of the four corner portions is immersed in a storage tank for the conductive paste provided below the multilayer body in the vertical direction, and then is lifted up from the storage tank to apply the conductive paste to the at least one of the end surface.

7. The manufacturing method according to claim 6, further comprising:
polishing the multilayer body so as to round the four corner portions before the forming of the external electrodes.

8. The manufacturing method according to claim 6, wherein
the conductive paste contains nickel or copper as a main component.
